(19) United States
(12) Patent Application Publication
(10) Pub. No.: US 2021/0328717 A1
(43) Pub. Date: Oct. 21, 2021

(54) Audio data recovery method, device and Bluetooth Apparatus Device

(71) Applicant: Nanjing Zgmicro Company Limited, Nanjing (CN)

(72) Inventors: Yuhong FENG, Nanjing (CN); Haiye WANG, Nanjing (CN); Yun YUAN, Nanking (CN); Bin XU, Nanjing (CN); Yan XIONG, Nanjing (CN); Yinong ZHANG, Nanjing (CN); Xiaodong YANG, Nanjing (CN)

(21) Appl. No.: 17/359,606

(22) Filed: Jun. 27, 2021

Related U.S. Application Data
(63) Continuation of application No. PCT/CN2019/128775, filed on Dec. 26, 2019.

(30) Foreign Application Priority Data
Dec. 28, 2018 (CN) 201811623088.7

(51) Int. Cl. H04L 1/00; G10L 19/00; H04W 4/80

(52) U.S. Cl. CPC H04L 1/0061; H04L 1/0045; H04W 4/80; G10L 19/0017

(57) ABSTRACT

An audio data recovery method, an audio data recovery device and a Bluetooth device are provided in the present invention. The audio data recovery method comprises: receiving a plurality of audio data packets each comprising M segments of frame data and M CRC codes each corresponding to one of the M segments of frame data; and recovering one audio data packet according to the segments of frame data and the CRC codes in N audio data packets received incorrectly N times for the same audio data.

### CROSS-REFERENCES TO RELATED APPLICATIONS

This patent application is a continuation of PCT/CN2019/128775 filed Dec. 26, 2019, which claims the priority of Chinese Patent Application No. 201811623088.7 filed on Dec. 28, 2018 in China, the entire content of which is incorporated herein by reference.

### BACKGROUND OF THE INVENTION

### Field of the Invention

The present invention relates to the field of Bluetooth technology, and in particular to an audio data recovery method, an audio data recovery device and a Bluetooth device.

### Description of the Related Art

Bluetooth audio broadcasting means that a master Bluetooth speaker broadcasts audio data from a mobile phone through a wireless connection channel (BR/EDR Synchronization Scan Channel) while receiving the audio data from the mobile phone, and other slave speakers can play the audio data simultaneously, and also wirelessly. However, the Bluetooth wireless connection is less stable than wired connection. The sound from the speaker may be stuck when the interference is large or the connection distance is long. Some of the disadvantages of the Bluetooth audio broadcasting include poor audio quality from audio data transmission error when there is large interference or a long connection distance.

Therefore, there is a need for an improved technical solution to solve the above-mentioned problems.

### SUMMARY OF THE INVENTION

In general, the present invention is related to an audio data recovery method, an audio data recovery device and a Bluetooth device.

According to one aspect of the present invention, an audio data recovery method comprises: receiving a plurality of audio data packets each comprising M segments of frame data and M CRC codes each corresponding to one of the M segments of frame data; and recovering one audio data packet according to the segments of frame data and the CRC codes in N audio data packets received incorrectly N times for the same audio data, wherein M and N are positive integers.

According to another aspect of the present invention, an audio data recovery device comprises: a receiving module configured for receiving a plurality of audio data packets each comprising M segments of frame data and M CRC codes each corresponding to one of the M segments of frame data; and a recovery module configured for recovering one audio data packet according to the segments of frame data and the CRC codes in N audio data packets received incorrectly N times for the same audio data; wherein M and N are positive integers.

According to yet another aspect of the present invention, a Bluetooth device comprises the above audio data recovery device. The incorrect audio data packet is recovered by adding several CRC codes to the audio data packet in the present invention. When the audio data packets transmitted many times for the same audio data are still incorrect, the received incorrect audio data packets are not discarded, but used for error correction and data recovery, thereby effectively increasing the transmission distance of audio broadcasting and avoiding stuck audio even under interference conditions.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 shows a schematic flowchart of an audio data recovery method according to a first embodiment of the present invention;

FIG. 2 shows a schematic structural diagram of an audio data recovery device according to a second embodiment of the present invention;

FIG. 3 shows a schematic structural diagram of a Bluetooth device according to a third embodiment of the present invention;

FIG. 4 shows a schematic structure of three Bluetooth data packets received by a host layer;

FIG. 5 shows a schematic diagram of a data stream format of an SBC frame;

FIG. 6 shows a block diagram of an SBC decoder according to one embodiment of the present invention;

FIG. 7 shows a processing flow of three incorrect frames; and

FIG. 8 shows a schematic diagram of distribution of subband samples obtaining by decoding the SBC frame.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

In order to solve at least the problem of packet loss and packet error in the data transmission, Bluetooth audio broadcast transmission uses a data retransmission mechanism to ensure audio quality. However, the incorrect retransmission data packets will be discarded directly in the prior art, which not only wastes the incorrect retransmission data packets, but also can not recover the incorrect data packet successfully, resulting in lost or hesitant audio.

It can be found that not all the data in the incorrect data packet is incorrect, and the incorrect location in the repeated incorrect data packets representing for the same data stream may be different. Therefore, it is proposed that one or more CRC (Cyclic Redundancy Check) codes can be added to the data packet in segments, and the CRC code in the repeated incorrect data packets transmitted multiple times for the same data stream can be used to recover the incorrect data packet. The data packet can be recovered as complete as possible according to the CRC code and the repeated incorrect data packets.

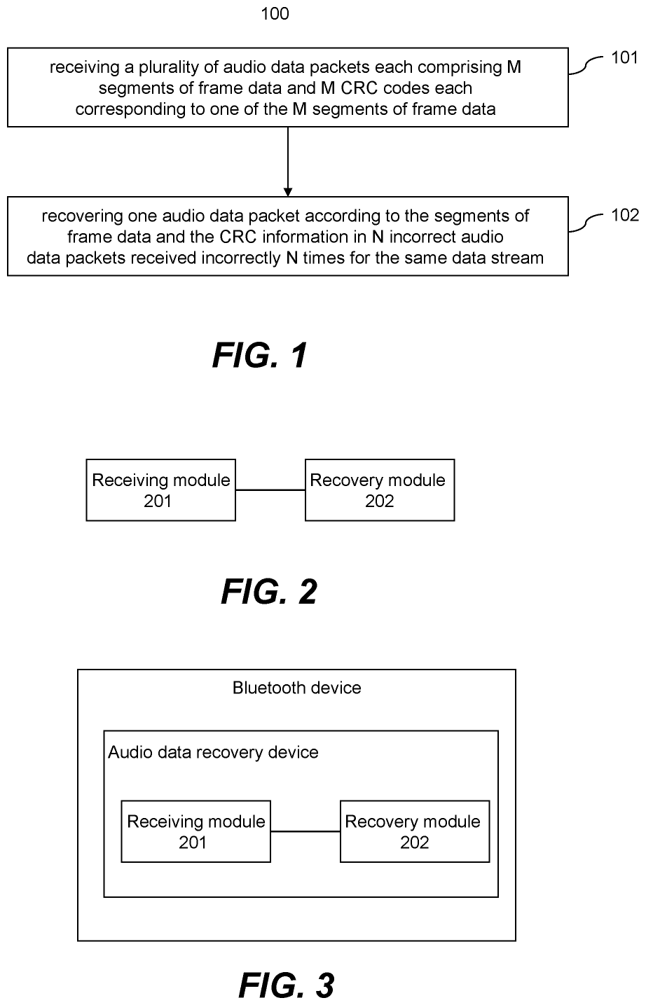

Embodiments of the present invention are discussed herein with reference to FIGS. 1-8. However, those skilled in the art will readily appreciate that the detailed description given herein with respect to these figures is for explanatory purposes as the invention extends beyond these limited embodiments.

Referring now to the drawings, in which like numerals refer to like parts throughout the several views. FIG. 1 shows a schematic flowchart of an audio data recovery method 100 according to a first embodiment of the present invention. At 101, a plurality of audio data packets are received in order. Each audio data packet includes M segments of frame data and M CRC codes, each corresponding to one of the M segments of frame data, where M is a positive integer.

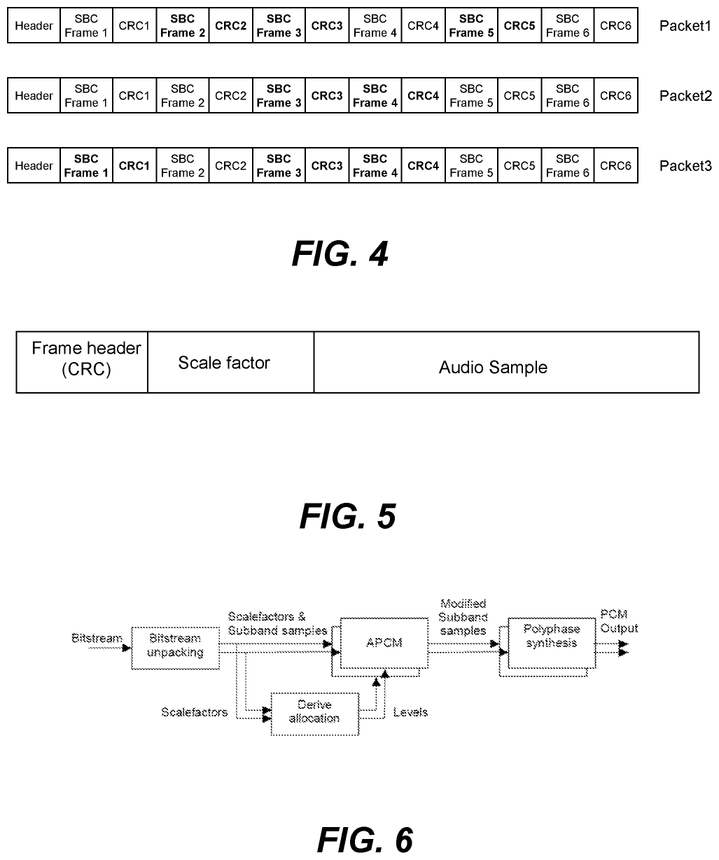

In one embodiment of the present invention, each audio data packet is divided into a plurality of segments and a plurality of CRC code is added into the audio data packet for data error correction. As shown in FIG. 4, each audio data packet includes a header, six segments of frame data and six CRC codes. Namely, M=6 in the example shown in FIG. 4. In other embodiments, M can be any positive integer, such as 2, 4, 7, and so on. Each CRC code corresponds to one segment of frame data. As shown in FIG. 4, each segment includes one frame of data. In other embodiments, each segment may include two or more frames of data.

Depending on an implementation, the CRC code can be place at a tail or a head of the corresponding segment of frame data, or the CRC code can be placed at the tail or the head of the audio data packet centrally. The position of the CRC code in the audio data packet is not limited in the present invention. In one embodiment, when the audio data packet is transmitted via Bluetooth connection, a CONTROLLER layer of a receiving end will upload the audio data packet to a HOST layer of the receiving end directly if the audio data packet received during the transmission window is correct. If the received audio data packet is incorrect, the audio data packet will be retransmitted one or more times in one or more retransmission windows. The retransmitted audio data packet is identical with the audio data packet previously transmitted, and the audio data packets represent for the same audio data. If the correct audio data packet is not received in the preset number N of transmission windows (including retransmission windows), all the N incorrect audio data packets representing for the same audio data are uploaded to the HOST layer.

Returning back to FIG. 1, at 102, the audio data packet is recovered according to the segments of frame data and the CRC codes in the N incorrect audio data packets received incorrectly N times for the same audio data. where N is a positive integer.

The HOST layer recovers the audio data packet as complete as possible according to the segments of frame data and the CRC code in the incorrect audio data packets representing for the same audio data. When the audio data packets retransmitted many times are still incorrect, the received incorrect audio data packets are not discarded, but used for error correction and data recovery, thereby effectively increasing the transmission distance of audio broadcasting and avoiding lost audio even under interference conditions.

In one embodiment, each of the M segments of frame data of the audio data packet is recovered according to the N segments of frame data and the N CRC codes in the N incorrect audio data packets corresponding to the each of the M segments of frame data until all the M segments of frame data of the audio data packet are recovered.

Since the audio data packets retransmitted N times are redundant transmissions of the same audio data, each segment of frame data can be recovered according to the N segments of frame data and the N CRC codes corresponding to the each segment of frame data. Assuming that the audio data packets are received 3 times repeatedly and each audio data packet includes 5 segments of frame data. Then, there are 3 CRC codes for each segment of frame data. For example, for the first segment of frame data, the 3 CRC codes comprises: the CRC code of the first segment of frame data in the first audio data packet, the CRC code of the first segment of frame data in the second audio data packet, and the CRC code of the first segment of frame data in the third audio data packet. The first segment of frame data can be recovered based on the three CRC codes and the three first segments of frame data. In the same way, the second segment of frame data can be recovered based on the three CRC codes and the three second segments of frame data. The third, fourth and fifth segments of frame data can be recovered based on the three CRC codes and the three third, fourth and fifth segments of frame data respectively.

In one embodiment, each of the M segments of frame data of the audio data packet is recovered by: detecting the N CRC codes in the N incorrect audio data packets corresponding to the each of the M segments of frame data; and retaining one segment of frame data having correct CRC code for the each of the M segments of frame data if the CRC code of at least one segment of frame data in the N segments of frame data in the N incorrect audio data packets is correct, or, uploading the N segments of frame data having the incorrect CRC code for the each of the M segments of frame data to a decoder for data recovery if the CRC codes of all the N segments of frame data in the N incorrect audio data packets are incorrect.

For example, assuming that three incorrect audio data packets A, B, and C representing for the same audio data are received. For the first segment of frame data, if the CRC code of the first segment of frame data in the audio data packet A is wrong, it continues to check whether the CRC code of the first segment of frame data in the audio data packet B is correct. If it is correct, it means the first segment of frame data in the audio data packet B is correct, the first segment of frame data in the audio data packet B is reserved as the correct first segment of frame data. If the CRC code of the first segment of frame data in the audio data packet B is wrong, then it continues to check whether the first segment of frame data in the audio data packet C is correct. If it is correct, it means that the first segment of frame data in the audio data packet C is correct, and the first segment of frame data in the audio data packet C is reserved as the correct first segment of frame data. If the CRC code of the first segment of frame data in the audio data packet C is wrong, all the first segments of frame data in the audio data packets A, B, and C are updated to the decoder for data recovery.

For the second segment of frame data, if the CRC code of the second segment of frame data in the audio data packet A is wrong, whether the CRC code of the second segment of frame data in the audio data packet B is correct is determined. If it is correct, it means the second segment of frame data in the audio data packet B is correct, the second segment of frame data in the audio data packet B is reserved as the correct second segment of frame data. If the CRC code of the second segment of frame data in the audio data packet B is wrong, then it continue to check whether the second segment of frame data in the audio data packet C is correct. If it is correct, it means that the second segment of frame data in the audio data packet C is correct, then the second segment of frame data in the audio data packet C is reserved as the correct second segment of frame data. If the CRC code of the second segment of frame data in the audio data packet C is wrong, all the second segments of frame data in the audio data packets A, B, and C are uploaded to the decoder for data recovery.

The process described above can be used for recover other segments of frame data.

As described above, each segment of frame data may comprises one frame of data, or may comprise a plurality of frames of data. In one embodiment, the decoder recovers one frame of data in the uploaded segment of frame data according to the N segments of frame data all having the incorrect CRC code in the N incorrect audio data packets by: detecting a frame header CRC code in a frame header of the one frame of data in the uploaded segment of frame data, decoding the frame of data normally if the frame header CRC code is correct, and performing a bad frame recovery process if the frame header CRC code is incorrect, when N=1; and, performing error correction on the one frame of data in a subband sample domain according to the frame header CRC codes in the frame headers of the N frames of data of the N segments of frame data in the N incorrect audio data packets and then decoding when N>1, and performing the bad frame recovery process if the number of error subband samples exceeds a preset value.

Depending on implementation, if the decoder receives one incorrect frame of data, the frame header CRC code of the incorrect frame of data is detected. If the frame header CRC code passes, the incorrect frame of data is decoded normally. Otherwise, a packet loss concealment (PLC) algorithm as the bad frame recovery process is performed to recover the incorrect frame of data. If the decoder receives two or three incorrect frames of data, error correction can be performed based on multiple redundant frames in the subband sample domain, and then the incorrect frames of data are decoded normally after the error correction. If there are too many error subband samples, the PLC algorithm as the bad frame recovery process is performed to recover the incorrect frame of data.

In one embodiment, the error correction in a subband sample domain includes: copying the frame header and a scale factor of at least one uploaded frame with correct frame header CRC code into other frames; decoding the N uploaded frames to obtain a plurality of subband samples of the N uploaded frames; and recovering the incorrect subband sample based on the subband samples of the N uploaded frames.

In one embodiment, the recovering the incorrect subband sample based on the subband samples of the N uploaded frames may be: after one subband sample is determined to be incorrect, the previous subband sample of the same subband relative to the incorrect subband sample can be repeated as the recovered subband sample of the incorrect subband sample, or a simple linear interpolation of the previous subband sample and the next subband sample of the same subband relative to the incorrect subband sample can be used as the recovered subband sample of the incorrect subband sample, or more complex interpolation based on AR models can also be used to recover the incorrect subband sample.

After the multiple subband samples are obtained by decoding, the subband samples are compared in order and an array is recorded. For example, if the three subband samples are identical, one element of the array corresponding to the subband sample is recorded as 0; if the two subband samples are identical, the different subband sample is replaced by the identical subband samples, and one element of the array corresponding to the subband sample is recorded as 2; if the three subband samples are different from one another, the subband sample are determined to be incorrect, one element of the array corresponding to the subband sample is recorded as 1, and the number of the error subband samples is increased by 1.

After all the subband samples are compared, it is determined whether the number of error subband samples is greater than the preset value. If the number of error subband samples is greater than the preset value, it means that there are too many error subband samples. The PLC algorithm is performed according to the frame loss. If the number of error subband samples is not greater than the preset value, the array is traversed, and the error correction processing is performed on the incorrect subband samples having the elements of the array equal to 1.

In one embodiment, the PLC algorithm is used as the bad frame recovery processing to recover the bad frames. In specific implementation, the current bad frame can be recovered by using an all-zero data frame, or repeating the previous good frame data, or using other packet loss concealment methods, which is not limited in this application.

In one embodiment, the audio data required to be transmitted is encoded by an SBC encoder in advance. Each segment of frame data of the audio data packet comprises one SBC frame. Namely, one audio data packet comprises M SBC frames and the M CRC codes each corresponding to one SBC frame.

Before transmitting the audio data, the audio data is required to be compressed usually. In one embodiment, the Bluetooth broadcast uses 2DH5 packets, and a payload length of each packet is 679 bytes. In order to save bandwidth, an SBC encoder is used to compress the audio data. The specific compression process is not described in detail in the present invention.

The 2DH5 packet includes a plurality of SBC frames usually. Each SBC frame has a fixed length of 128 samples, and the time length of each SBC frame is 2.9 ms (assuming a sampling frequency is 44.1 kHz). The audio data packet compressed by the SBC encoder includes M SBC frames, and each SBC frame corresponds to one CRC code. In one embodiment, the CRC code of each SBC frame is a 2-byte CRC16.

In one embodiment of the present invention, the incorrect Bluetooth transmission data packet can be recovered by adding several CRC bytes in the Bluetooth transmission data packet. When the incorrect data packets cannot be recovered through the CRC codes, the SBC decoder uses error correction process method to recovery the incorrect data packet.

Based on the same concept, an audio data recovery device is provided according to a second embodiment of the present invention. Since a principle of the audio data recovery device to solve the problem is similar to the method provided in the first embodiment of the present invention, the implementation of the audio data recovery device can refer to the implementation of the audio data recovery method, and the repetition will not be repeated.

FIG. 2 shows a schematic structural diagram of an audio data recovery device according to a second embodiment of the present invention. As shown in the figure, the audio data recovery device includes: a receiving module 201 configured for receiving a plurality of audio data packets each comprising M segments of frame data and M CRC codes each corresponding to one of the M segments of frame data; and a recovery module 202 configured for recovering one audio data packet according to the segments of frame data and the CRC codes in N audio data packets received incorrectly N times for the same audio data; wherein, M, N are positive integers.

When the audio data packets retransmitted many times are still incorrect, the audio data recovery device provided according to one embodiment of the present invention does not discard the incorrect audio data packets, but makes full use of the redundancy in the audio data packets retransmitted many times for error correction and data recovery, thereby effectively increasing the transmission distance of audio broadcasting and avoiding stuck audio even under interference conditions.

In one embodiment, the recovery module is configured for: recovering each of the M segments of frame data of the one audio data packet according to the N segments of frame data and the N CRC codes in the N incorrect audio data packets corresponding to the each of the M segments of frame data until all the M segments of frame data of the one audio data packet are recovered.

In one embodiment, the recovery module comprises: a detection unit configured for detecting the N CRC codes in the N incorrect audio data packets corresponding to the each of the M segments of frame data; and a processing unit configured for retaining one segment of frame data having correct CRC code for the each of the M segments of frame data if the CRC code of at least one segment of frame data in the N segments of frame data in the N incorrect audio data packets is correct, or, uploading the N segments of frame data having the incorrect CRC codes for the each of the M segments of frame data for data recovery if the CRC codes of all the N segments of frame data in the N incorrect audio data packets are incorrect.

In one embodiment, each segment of frame data comprises one or more frames of data, and the decoder comprises: a first recovery unit configured for detecting a frame header CRC code in a frame header of one frame of data, decoding the one frame of data normally if the frame header CRC code is correct, and performing a bad frame recovery process if the frame header CRC code is incorrect, when N=1; a second recovery unit configured for performing error correction in a subband sample domain according to the frame header CRC codes in the frame headers of the N frames of data of the N segments of frame data in the N incorrect audio data packets and then decoding when N>1, and sending a bad frame recovery notification if the number of error subband samples exceeds a preset value; and a third recovery unit configured for performing the bad frame recovery process if the bad frame recovery notification is received.

In one embodiment, the second recovery unit comprises: a copy subunit configured for copying the frame header and a scale factor of at least one frame having the correct frame header CRC code into other frames; a decoding subunit configured for decoding the N frames to obtain a plurality of subband samples of the N frames; a recovery subunit configured for recovering error subband samples based on the subband samples of the N frames; and a sending subunit configured for sending the bad frame recovery notification if the number of error subband samples exceeds a preset value.

In one embodiment, the audio data required to be transmitted via Blueteeth connection is encoded by an SBC encoder in advance. Each segment of frame data of the audio data packet comprises one SBC frame. Namely, one audio data packet comprises M SBC frames and the M CRC code each corresponding to one SBC frame.

Based on the same concept, a Bluetooth device is provided according to a third embodiment of the present invention. Since a principle of the Bluetooth device to solve the problem is similar to the method provided in the first embodiment of the present invention, the implementation of the Bluetooth device can refer to the implementation of the audio data recovery method, and the repetition will not be repeated.

FIG. 3 shows a schematic structural diagram of a Bluetooth device according to a third embodiment of the present invention. As shown in FIG. 3, the Bluetooth device includes the audio data recovery apparatus as shown in the second embodiment of the present invention.

The Bluetooth device according to one embodiment of the present invention may include Bluetooth headsets, Bluetooth speakers, Bluetooth gateways, Bluetooth MP3, Bluetooth flash disks, Bluetooth vehicle-mounted devices, Bluetooth adapters, etc., which are not limited by the present invention.

The Bluetooth device provided according to the third embodiment of the present invention does not discard the incorrect audio data packets when the audio data packets retransmitted many times are still incorrect, but make full use of the incorrect audio data packets for error correction and data recovery, thereby effectively increasing the transmission distance of audio broadcasting and avoiding stuck audio even under interference conditions.

FIG. 4 shows a schematic structure of three repeated Bluetooth data packets received by a Host layer according to a fourth embodiment. As shown in FIG. 4, each Bluetooth data packet includes 6 SBC frames, and each SBC frame is followed by a CRC code with 2 bytes. In FIG. 4, each segment of frame comprises one SBC frame. The CRC code of each SBC frame can be placed at the tail of the SBC frame (as shown in FIG. 4), or at the head of the SBC frame, or concentrated at the tail or the head of the Bluetooth data packet.

As shown in FIG. 4, all the three data packet 1, 2, 3 are incorrect data packet, and the incorrect frames in the three data packet 1, 2, 3 are displayed in bold. In the first packet, there are three correct SBC frames 1, 4, and 6, and three incorrect SBC frames 2, 3, and 5. In the second data packet, there are four correct SBC frames 1, 2, 5 and 6, there are two incorrect SBC frames 3, and 4. In the third packet, there are three correct SBC frames 2, 5 and 6, and three incorrect SBC frames 1, 3 and 4. It should be noted that the SBC frame will be determined to be correct if the CRC code of the SBC frame is correct or passes, the SBC frame will be determined to be incorrect if the CRC code of the SBC frame is incorrect or does not pass.

Since these three data packets are three redundant transmissions of the same SBC data stream, the data packet can be recovered as much as possible by combining the SBC frames in the three data packets. For example, the SBC frame 1 in the first packet is correct, so the SBC frames 1 in the first packet is reserved as the recovered SBC frame 1. The SBC frame 2 in the second packet is correct, so the SBC frame 2 in the second packet is reserved as the recovered SBC frame 2. In the same way, the SBC frame 4 in the first packet, the SBC frame 5 in the second packet, the SBC frame 6 in the first packet are reserved as the recovered SBC frames 4, 5 and 6. All the three SBC frames 3 in the three data packets are incorrect, so the recovered SBC frame 3 cannot be obtained directly.

In one embodiment, for the three incorrect data packets, the CRC check corresponding to each SBC frame is performed in turn. If the CRC check of the SBC frame in the first data packet passes, the correct SBC frame in the first data packet is retained. If the CRC check of the SBC frame in the first data packet fails, it continues to perform the CRC check of the SBC frame at the corresponding position in the second data packet. If the CRC check of the SBC frame in the second data packet passes, the correct SBC frame in the second data packet is retained. If the CRC check of the SBC frame in the second data packet fails, it continues to perform the CRC check of the SBC frame at the corresponding position in the third data packet. If the CRC check of the SBC frame in the third data packet passes, the correct SBC frame in the third data packet is retained. If all the CRC checks of the SBC frames in the three data packets fail, the three incorrect SBC frame data are uploaded to the SBC decoder.

By checking the CRC code of each SBC frame in the three incorrect data packets, one correct SBC frame or three incorrect SBC frames for each SBC frame of the data packet will be uploaded to the SBC decoder.

In one embodiment, if the Host layer receives two incorrect data packets, the Host layer will upload one correct SBC frame or two incorrect SBC frames for each SBC frame of the data packet to the SBC decoder by checking the CRC code of each SBC frame in the two incorrect data packets. If the Host layer receives one incorrect data packet, the Host layer will upload one correct SBC frame or one incorrect SBC frame for each SBC frame of the data packet to the SBC decoder by checking the CRC code of each SBC frame in the one incorrect data packet. If the Host layer does not receive the data packet, that is, all three data packets are lost, the SBC decoder is notified that the current SBC frame is lost and the PLC algorithm needs to be used to compensate.

FIG. 5 shows a schematic diagram of a data stream format of a SBC frame. As shown in the FIG. 5, the SBC frame includes a frame header comprising a frame header CRC code, a scale factor, and a plurality of audio samples. The frame header CRC code only protects the frame header and the scale factor, does not protects the audio sample.

FIG. 6 shows a block diagram of a SBC decoder according to one embodiment of the present invention. As shown in the FIG. 6, the SBC decoder firstly performs bitstream unpacking after receiving the bitstream, then sends the scale factor and the subband samples obtained by decoding to an adaptive pulse code modulation (APCM) decoder, calculates a bit allocation information (Derive allocation) according to the scale factor at the same time, then calculates quantized levels based on the bit allocation information, sends the quantized levels to the APCM decoder, then dequantizes the subband samples to obtain the modified subband samples by the APCM decoder, and then sends sent the modified subband samples to a synthesis filter module to output finally.

In one embodiment, the SBC decoder processes the incorrect SBC frame as follows. If one incorrect SBC frame is received, the frame header CRC code is detected. If the frame header CRC code passes, the SBC frame will be decoded normally. If the frame header CRC code fails, the incorrect SBC frame will be recovered by the PLC algorithm. If two or three incorrect SBC frames are received, the incorrect SBC frame is corrected in the subband sample domain by using the redundant information of the two or three incorrect SBC frames. The incorrect SBC frame is will be recovered by the PLC algorithm if the number of error subband samples exceeds a preset value. The correction of the incorrect subband samples refers to the subband sample domain located between the APCM decoder and the synthesis filter module, rather than the time domain PCM.

The following takes the processing of three incorrect SBC frames as an example for description.

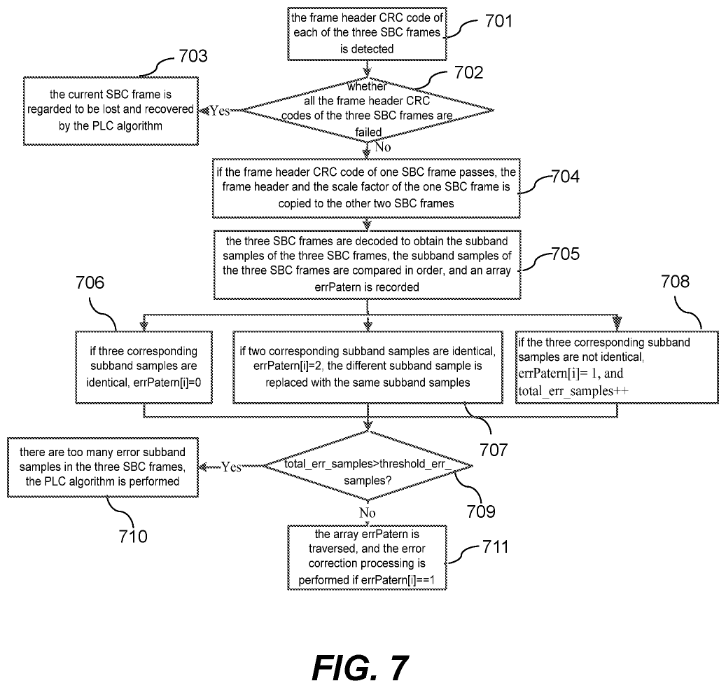

FIG. 7 shows a processing flow of three incorrect SBC frames. As shown in FIG. 7, assuming that the SBC decoder receives three incorrect SBC frames. At 701, the frame header CRC code of each of the three SBC frames is detected. At 702, it is determined whether all the frame header CRC codes of the three SBC frames are failed. If yes, the current SBC frame is determined to be lost or incorrect and recovered by the PLC algorithm at 703. At 704, if the frame header CRC code of one SBC frame passes, the frame header and the scale factor of the one SBC frame is copied to the other two SBC frames. At 705, the three SBC frames are decoded to obtain the subband samples of the three SBC frames, the subband samples of the three SBC frames are compared in order, and an array errPatern is recorded. At 706, if three corresponding subband samples are identical, errPatern[i]=0. At 707, if two corresponding subband samples are identical, errPatern[i]=2, the different subband sample is replaced with the same subband samples. At 708, if the three corresponding subband samples are not identical, errPatern[i]=1, then the total number of error subband samples total_err_samples++. The subband sample i of the SBC frame is determined to be incorrect and should be corrected by an error correction processing if errPatern[i]=1. At 709, it is determined whether the total number of error subband samples total_err_samples is greater than the preset value threshold_err_samples.

If the total number of error subband samples total_err_samples is greater than the preset value threshold_err_samples, it means that there are too many error subband samples in the three SBC frames, the SBC frame is determined to be lost, the PLC algorithm is performed to recover the lost SBC frame at 710. Otherwise, the array errPatern is traversed, and the error correction processing is performed if errPatern[i]==1 at 711.

After one of the subband samples (block n) is determined to be incorrect, the error correction processing is performed as following specifically: the previous subband sample of the same subband relative to the incorrect subband sample can be repeated as the recovered subband sample of the incorrect subband sample, or a simple linear interpolation of the previous subband sample (block n−1) and the next subband sample (block n+1) of the same subband relative to the incorrect subband sample can be used as the recovered subband sample of the incorrect subband sample, or more complex interpolation based on AR models can also be used to recover the incorrect subband sample.

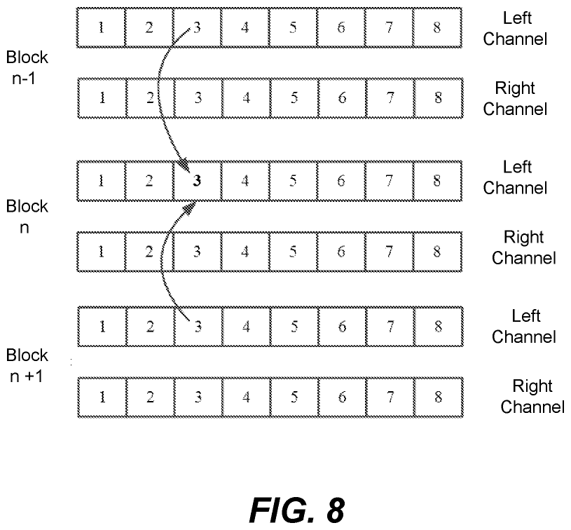

FIG. 8 shows a schematic diagram of the distribution of subband samples obtaining by decoding the SBC frame. The SBC code is based on 8 sub-band stereo coding, block n−1, block n, block n+1 represent three adjacent blocks in order, and each block includes 8 sub-band samples which are stored in the left and right channels respectively.

If the SBC decoder determines that the current SBC frame is lost or incorrect, the current SBC frame can be recovered by the PLC algorithm. In one embodiment, the all-zero SBC frame or the previous correct SBC frame can be reserved as the recovered SBC frame of the loss or incorrect SBC frame.

According to one aspect of the present invention, the present invention can be implemented as a nonvolatile computer-readable medium. The nonvolatile computer-readable medium comprises instructions executed by a processor. The instructions cause the processor to perform: capturing ambient sound; detecting the ambient sound, and triggering the headphone to enter an interactive mode when a preset interested sound appears in the ambient sound; controlling the headphone to output an interactive reminder in the interactive mode. The interactive reminder comprises one type or a combination of multiple types of a visual reminder, a tactile reminder and an auditory reminder.

Those skilled in the art should be aware that the embodiments of this application may be methods, systems, or computer program products. Accordingly, the present application may take the form of a complete hardware embodiment, a complete software embodiment, or an embodiment in conjunction with software and hardware aspects. Furthermore, the present application may take the form of a computer program product implemented on one or more computer-available storage media (including, but not limited to, disk memory, CD-ROM, optical memory, etc.) containing computer-available program code.

The present application is described with reference to methods, equipment (systems), and flow charts and/or block diagrams of computer program products according to the embodiment of the present application. It should be understood that each flow and/or block in a flowchart and/or block diagram, as well as the combination of flow and/or block in a flowchart and/or block diagram, can be implemented by computer program instructions. These computer program instructions may be provided to a processor of a general purpose computer, a dedicated computer, an embedded processor, or other programmable data processing device to produce a machine such that instructions executed by a processor of a computer or other programmable data processing device produce instructions for implementing a flow chart or more. A device for processes and/or block diagrams or functions specified in a box or multiple boxes.

These computer program instructions may also be stored in a computer-readable memory that may guide a computer or other programmable data processing device to work in a particular way, such that the instructions stored in the computer-readable memory generate a manufacturer including an instruction device that is implemented in a flow chart one or more processes. Process and/or block diagram, a box or function specified in multiple boxes.

These computer program instructions may also be loaded on a computer or other programmable data processing device such that a series of operational steps are performed on a computer or other programmable device to produce computer-implemented processing, thereby providing instructions executed on a computer or other programmable device for implementing a flow chart. The steps of a process or multiple processes and/or block diagrams, or functions specified in a box.

Although preferred embodiments of the present application have been described, additional changes and modifications to these embodiments may be made once the basic creative concepts are known to those skilled in the art. The appended claims are therefore intended to be interpreted to include preferred embodiments and all changes and modifications falling within the scope of this application.

Obviously, a person skilled in the art may make various changes and variations to the application without departing from the spirit and scope of the application. Thus, if these modifications and variations of this application fall within the scope of the claims and their equivalent technologies, the application is also intended to include these changes and variations.

We claim:

1. An audio data recovery method comprising:
receiving a plurality of audio data packets, each including M segments of frame data and M CRC codes each corresponding to one of the M segments of frame data; and
recovering one audio data packet according to the segments of frame data and the CRC codes in N audio data packets received incorrectly N times for the same audio data, wherein M and N are positive integers.

2. The method according to claim 1, wherein said recovering one audio data packet comprises:
recovering each of the M segments of frame data of the one audio data packet according to the N segments of frame data and the N CRC codes in the N incorrect audio data packets corresponding to the each of the M segments of frame data until all the M segments of frame data of the one audio data packet are recovered.

3. The method according to claim 2, wherein said recovering each of the M segments of frame data of the one audio data packet comprises:
detecting the N CRC codes in the N incorrect audio data packets corresponding to the each of the M segments of frame data; and
retaining one segment of frame data having correct CRC code for the each of the M segments of frame data if the CRC code of at least one segment of frame data in the N segments of frame data in the N incorrect audio data packets is correct, or, uploading the N segments of frame data having the incorrect CRC codes for the each of the M segments of frame data for data recovery if the CRC codes of all the N segments of frame data in the N incorrect audio data packets are incorrect.

4. The method according to claim 3, wherein each segment of frame data comprises one or more frames of data, and the decoder recovers one frame of data of the one audio data packet according to the N segments of frame data all having the incorrect CRC codes in the N incorrect audio data packets by:
detecting a frame header CRC code in a frame header of one frame of data, decoding the one frame of data normally if the frame header CRC code is correct, and performing a bad frame recovery process if the frame header CRC code is incorrect, when N=1; and
performing error correction in a subband sample domain according to the frame header CRC codes in the frame headers of the N frames of data of the N segments of frame data in the N incorrect audio data packets and then decoding when N>1, and performing the bad frame recovery process if the number of error subband samples exceeds a preset value.

5. The method according to claim 4, wherein said performing error correction in a subband sample domain according to the frame header CRC codes in the frame headers of the N frames of data of the N segments of frame data in the N incorrect audio data packets comprises:
copying the frame header and a scale factor of at least one frame having the correct frame header CRC code into other frames;
decoding the N frames to obtain a plurality of subband samples of the N frames; and
recovering error subband samples based on the subband samples of the N frames.

6. The method according to claim 4, wherein the bad frame recovery process comprises:
using a packet loss concealment PLC algorithm to recover the bad frame.

7. The method according to claim 1, wherein the audio data pocket is pre-encoded by an SBC encoder, and each segment of frame data of the audio data packet comprises one SBC frame.

8. An audio data recovery device comprising:
a receiving module configured for receiving a plurality of audio data packets each comprising M segments of frame data and M CRC codes each corresponding to one of the M segments of frame data; and
a recovery module configured for recovering one audio data packet according to the segments of frame data and the CRC codes in N audio data packets received incorrectly N times for the same audio data, wherein M and N are positive integers.

9. The device according to claim 8, wherein the recovery module is configured for:
recovering each of the M segments of frame data of the one audio data packet according to the N segments of frame data and the N CRC codes in the N incorrect audio data packets corresponding to the each of the M segments of frame data until all the M segments of frame data of the one audio data packet are recovered.

10. The device according to claim 9, wherein the recovery module comprises:
a detection unit configured for detecting the N CRC codes in the N incorrect audio data packets corresponding to the each of the M segments of frame data; and
a processing unit configured for retaining one segment of frame data having correct CRC code for the each of the M segments of frame data if the CRC code of at least one segment of frame data in the N segments of frame data in the N incorrect audio data packets is correct, or, uploading the N segments of frame data having the incorrect CRC codes for the each of the M segments of frame data for data recovery if the CRC codes of all the N segments of frame data in the N incorrect audio data packets are incorrect.

11. The device according to claim 10, wherein each segment of frame data comprises one or more frames of data, and the decoder comprises:
a first recovery unit configured for detecting a frame header CRC code in a frame header of one frame of data, decoding the one frame of data normally if the frame header CRC code is correct, and performing a bad frame recovery process if the frame header CRC code is incorrect, when N=1;
a second recovery unit configured for performing error correction in a subband sample domain according to the frame header CRC codes in the frame headers of the N frames of data of the N segments of frame data in the N incorrect audio data packets and then decoding when N>1, and sending a bad frame recovery notification if the number of error subband samples exceeds a preset value; and
a third recovery unit configured for performing the bad frame recovery process if the bad frame recovery notification is received.

12. The device according to claim 11, wherein the second recovery unit comprises:
a copy subunit configured for copying the frame header and a scale factor of at least one frame having the correct frame header CRC code into other frames;
a decoding subunit configured for decoding the N frames to obtain a plurality of subband samples of the N frames;
a recovery subunit configured for recovering error subband samples based on the subband samples of the N frames; and
a sending subunit configured for sending the bad frame recovery notification if the number of error subband samples exceeds a preset value.

13. The device according to claim 11, wherein the third recovery unit is configured for using a packet loss concealment PLC algorithm to recover the bad frame.

14. The device according to claim 8, wherein the audio data pocket is pre-encoded by an SBC encoder, and each segment of frame data of the audio data packet comprises one SBC frame.

15. A Bluetooth device comprising:
an audio data recovery device comprising:
a receiving module configured for receiving a plurality of audio data packets each comprising M segments of frame data and M CRC codes each corresponding to one of the M segments of frame data; and
a recovery module configured for recovering one audio data packet according to the segments of frame data and the CRC codes in N audio data packets received incorrectly N times for the same audio data;
wherein M and N are positive integers.

16. The Bluetooth device according to claim 15, wherein the recovery module is configured for: recovering each of the M segments of frame data of the one audio data packet according to the N segments of frame data and the N CRC codes in the N incorrect audio data packets corresponding to the each of the M segments of frame data until all the M segments of frame data of the one audio data packet are recovered.

17. The Bluetooth device according to claim 16, wherein the recovery module comprises:
a detection unit configured for detecting the N CRC codes in the N incorrect audio data packets corresponding to the each of the M segments of frame data; and
a processing unit configured for retaining one segment of frame data having correct CRC code for the each of the M segments of frame data if the CRC code of at least one segment of frame data in the N segments of frame data in the N incorrect audio data packets is correct, or, uploading the N segments of frame data having the incorrect CRC codes for the each of the M segments of frame data for data recovery if the CRC codes of all the N segments of frame data in the N incorrect audio data packets are incorrect.

18. The Bluetooth device according to claim 17, wherein each segment of frame data comprises one or more frames of data, and the decoder comprises:
a first recovery unit configured for detecting a frame header CRC code in a frame header of one frame of data, decoding the one frame of data normally if the frame header CRC code is correct, and performing a bad frame recovery process if the frame header CRC code is incorrect, when N=1;
a second recovery unit configured for performing error correction in a subband sample domain according to the frame header CRC codes in the frame headers of the N frames of data of the N segments of frame data in the N incorrect audio data packets and then decoding when N>1, and sending a bad frame recovery notification if the number of error subband samples exceeds a preset value; and
a third recovery unit configured for performing the bad frame recovery process if the bad frame recovery notification is received.

19. The Bluetooth device according to claim 18, wherein the second recovery unit comprises:
a copy subunit configured for copying the frame header and a scale factor of at least one frame having the correct frame header CRC code into other frames;
a decoding subunit configured for decoding the N frames to obtain a plurality of subband samples of the N frames;
a recovery subunit configured for recovering error subband samples based on the subband samples of the N frames; and
a sending subunit configured for sending the bad frame recovery notification if the number of error subband samples exceeds a preset value.

20. The Bluetooth device according to claim 19, wherein the third recovery unit is configured for using a packet loss concealment PLC algorithm to recover the bad frame.
